(19) United States
(12) Patent Application Publication
(10) Pub. No.: US 2005/0069310 A1
(43) Pub. Date: Mar. 31, 2005

(54) Energy transmitter forming a component of a coating and/or drying installation, in particular for a paint coating

(76) Inventor: Helmut Reichelt, Reichstadt (DE)

Correspondence Address: McNair Law Firm, Post Office Box 10827, Greenville, SC, 29603-0827, US

(21) Appl. No.: 10/498,890

(22) PCT Filed: Nov. 30, 2002
(86) PCT No.: PCT/EP02/13551

(30) Foreign Application Priority Data
Dec. 22, 2001 (EP) 011307881

(51) Int. Cl. H05B 3/20; H05B 3/12

(52) U.S. Cl. 392/437

(57) ABSTRACT

For drying coatings and varnish, an energy transmitter (1) is provided comprising two transmitter surface elements (10) as antennas, with the transmitter elements (10) having a glass carrier plate (11) bearing a radiation layer (13) on a rear glass surface (12) whose opposite free front glass surface (17) is directed towards the surface of a component (3) to be dried. Spaced apart and parallel to the rear glass surface (12), a surface reflector (20) of a metal is positioned, with a corresponding radiation layer (13) for emitting electromagnetic radiation in a frequency band that covers the characteristic natural frequencies in ultrared of an object to be dried, the radiation layer (13) being excitable by means of a control device (16) to emit a frequency band so that natural frequencies of the object to be dried are excitable in resonance.

### CROSS REFERENCE TO RELATED APPLICATION

This application claims priority from European Patent Application No. 01130788.1 filed Dec. 22, 2001 and from PCT/EP02/13551 filed Nov. 30, 2002.

### FIELD OF THE INVENTION

This invention relates to an energy transmitter as a component part of a coating and/or drying plant, especially for a varnish or similar coating, that employs electromagnetic radiation of selected frequencies in the drying process.

### BACKGROUND OF THE INVENTION

For conventional varnishing processes, different varnishing materials are used, partly in several layers, such as powder varnishes, fillers, basic varnishes, clear varnishes, etc. which must be fused or, respectively, dried at reaction temperatures from approximately 80° to approximately 200°. In generally known coating plants which are designed for standard varnishings of many components—such as, for example, housings, vehicle bodies, structural metal parts, etc., conventional circulating air drying is performed with hot air which requires enormous energy costs and long drying periods. Here, hot air heated by heating elements is used as the energy transmitter. Regarding a continuous transport of the components through drying tunnels, these will have a great length so that correspondingly complex structures in large building complexes will be required. Aside from these coating and varnishing plants with conventional traditional circulating air heating by means of hot air, multi-stage processes are known in connection with other energy transmitters by which energy in the varnish coating is applied for the purpose of fusing and/or drying:

In one known varnishing plant, combined UV/IR (ultra violet/infra red) hardening is utilized wherein varnishing material to be hardened is irradiated alternately with IR radiation and with UV radiation in several consecutive radiation intervals. A special expensive varnishing material is required for this, with the application preferably being to repair varnishings.

Furthermore, in another known varnishing plant with a two-stage drying process used for varnish drying, with infrared radiators being used as energy transmitters in the first drying stage. One problem with these infrared radiators is that the radiation intensity and thus the effective energy charge in the coating material decreases by the square of the distance. Accordingly, the infrared radiators are adjusted in their shape precisely contoured to the object to be dried and, by means of controlled regulating devices, can be brought—by means of robots—up to a close distance from the surface so that a narrow space remains to increase the effectiveness. This presents a considerable expenditure in the way of apparatus. Thus, especially with more structured components, a continuous transport through a drying installation is obviously not possible since the object must be kept stationary at the location of the approached infrared radiators during the first drying stage. In a second drying room, post-drying is then performed as a second drying stage with mostly stationary infrared radiators for which, again, a considerable expenditure of time is required.

Furthermore, in yet another varnishing plant in which infrared drying is exclusively used which operates with a radiation frequency in near infrared (NIR) from 1.0 to 4.0 μm. Here, too, the aforementioned problems are apparent regarding an efficient energy application. There is the additional problem that covered areas such as, for example, undercut areas which IR radiation does not directly impinge upon will be only little heated and hardened.

In summary, it can be established that with the coating and varnishing plants known so far, fusing and/or hardening of coating materials requires very high expenditures in energy and time. This expenditure is also due to the fact that a component as a carrier of the coating material—especially with a good heat-conducting metal component itself as well as the ambient air—must be heated up to the required temperature of the coating material so that the adjoining coating material itself will be able to absorb the required high temperature. For components with greater masses of material, there will then be additionally the problem that the components heated up with great energy expenditure must again be cooled down in a time-consuming manner for further handling which, in turn, will require high energy consumption for active cooling.

Accordingly, it is an object of the present invention to provide an energy transmitter as a component part of a coating and/or drying plant, especially for varnish coating, which enables considerable savings in process energy.

### SUMMARY OF THE INVENTION

The above and other objects are accomplished according to a first aspect of the invention in which the energy transmitter comprises at least two transmitter surface elements as antenna elements. Each of the transmitter surface elements has a glass carrier plate which carries a radiation layer on a rear glass surface and whose opposite free front glass surface is directed toward a position for an object to be dried or for a surface of a component with coating material applied. A surface reflector of a metal material is arranged at a distance and approximately parallel to the rear glass surface and in at least its size.

The corresponding radiation layer is designed to give off electromagnetic radiation in a frequency band, with the frequency band at least covering characteristic natural frequencies in the ultrared of an object to be dried or of a coating material. Such molecular natural frequencies are ranging—especially in the ultrared range—from approximately 10⁻⁹ to 10⁻¹² hertz. By means of a control device, the radiation layer is excitable to give off at least the one frequency band so that natural frequencies of the object to be dried or of the coating material are excitable in resonance. In this case, the arrangement selects the correctly corresponding resonance frequency to a natural frequency from the radiated frequency band for a specific energy application with a high energy density according to the usual resonance processes. Thus, through a specific adjustment of the radiated frequency band to the correspondingly natural frequencies which are ascertainable by measuring techniques, especially those of varnishing materials, an energy input directly into these materials is possible with a high energy density without adjoining ambient areas, especially component carrier areas, being also heated up to high temperatures or, respectively, being only heated up a little. Moreover, in contrast to conventional IR radiators, there is only a minimal temperature increase in the radiation layer of the energy transmitters which are here operating as antenna elements. Since the components to be coated need not inevitably be also heated up to high temperatures, the cooling-down processes which are otherwise required after varnish drying can be saved or at least considerably reduced.

As a whole, coating and/or drying plants can thus be installed according to the invention which can be operated at considerably lower expenditures in energy and time.

Extensive tests have established that especially the indicated structure of the transmitter surface elements in combination with the surface reflector and the indicated radiation direction will lead to a considerable increase in efficiency.

In one arrangement of the transmitter surface elements, the elements are designed in rectangular or square form with planar glass surfaces and, overall, are preferably arranged in planes facing each other in at least one plane. This results in a simple structural design with advantageously large-area total radiation surfaces for an effective energy application. Tests have shown that particularly efficient radiation is possible with transmitter surface elements with edge lengths of approximately 20 cm to 80 cm, preferably of approximately 40 cm. In addition, a closed, gas-tight front plane can be employed as required.

In a particularly favorable aspect of the invention, the planes of the transmitter surface elements form the inside walls of a tunnel and are arranged on its side walls and/or on its ceiling wall and/or on the floor wall. Particularly, components for varnish drying can be transported in an automated fashion through such a tunnel.

In a further aspect of the invention, a radiation layer is provided which is highly suitable for the radiation of the indicated frequency bands. In this aspect, a radiation layer is formed on the glass carrier plates by applying the following coating mass which consists of a binding agent, insulator, dispersing agent, water and graphite and is composed of:

| | | |
|---|---|---|
| a. | 55 to 65% | amount of substance of a base material, |
| | | comprising: |
| | 39 to 49% | amount of substance binding agent, |
| | 18 to 23% | amount of substance insulator, |
| | 18 to 24% | amount of substance dispersing agent, |
| | 12 to 16% | amount of substance distilled water; and |
| b. | 35 to 45% | amount of substance graphite, |
| | | with the binding agent being composed of: |
| | 69.06 to 75.54% | amount of substance distilled water, |
| | 4 to 6% | amount of substance sulfonated oil, |
| | 0.16 to 0.24% | amount of substance phenols, or |
| | 0.05 to 0.5% | amount of substance |
| | | benzisothiazolinone, |
| | 15 to 19% | amount of substance casein, |
| | 0.8 to 1.2% | amount of substance urea, |
| | 2 to 3% | amount of substance thinning agent, |
| | | and |
| | 2.5 to 3.5% | amount of substance caprolactam. |

In still another aspect, in the composition mentioned immediately above, the sulfonated oil is sulfated ricinus oil, the phenols are carbonized phenols produced by cracking or that benzisothiazolinone is used, the thinning agent is an alkaline thinning agent and/or a solvent based on aromatics and/or alcohol and/or ester and/or ketone, the insulator is insulating soot, the dispersing agent is an inorganic and/or organic, monomer and/or polymer substance, and the coating material contains a thixotropic agent.

In a still further aspect, the transmitter surface elements have electrical conductors in each case on the opposite side areas of the rear glass surfaces provided with the radiation layer, all transmitter surface elements being connected in parallel with a harmonic generator of the control device. The harmonic generator comprises an electrical block which—upon control with a control oscillation—shows a steep current speed increase and thus being suitable for producing a high harmonic percentage. These conductors are preferably designed as copper foil strips, with the coupling to the radiation layer being capacitive or inductive. Suitable as an electronic block with the indicated characteristics is a Triac or a double MOSFET or, possibly, even an ultra high-speed switch. With such excitation, the radiation layer acts in the form of a frequency transformer, with relatively smaller excitation frequencies resulting in the high radiation frequencies with the indicated ultrared frequency band.

In an additional aspect, a number of the transmitter surface elements with a frequency in the megahertz range and the other transmitter surface elements may be excited with a frequency in the gigahertz range. Due to the aforementioned function of the radiation layer as a frequency converter or, respectively, a frequency multiplier at higher frequencies with regard to the corresponding excitation frequency, such a divided excitation of the transmitter surface elements will enable a broad coverage of natural frequency ranges if this is required for concrete applications. This may be the case, for example, if material mixes are used as coating materials which have relatively far-apart natural frequencies suitable for the resonance purposes in accordance with the invention.

In another additional aspect, the surface reflector may be formed of at least one load bearable metal plate on which the transmitter surface elements are held via insulation elements. For an optimum effect, the distance between the surface reflector and the transmitter surface elements is approximately 1 cm to 10 cm, preferably approximately at 4 cm. This distance is simply specifiable by a corresponding design of the insulation elements. Such an arrangement results in a simple and inexpensive structure. The surface reflector itself can, in turn, be mounted on suitable mounting structures or bearing walls—without the requirement of an electrical installation. In such an arrangement, the radiation layer is in the intermediate gap between the transmitter surface elements and the surface reflector and is thus advantageously protected even in rough operation against mechanical and possibly even chemical effects. In contrast, the uncoated glass surface facing to the outside is largely insensitive and can especially simply be kept clean which is essential for efficient and trouble-free radiation. The uncoated glass surfaces are not even attacked by the chemicals usually occurring in varnishing plants during fusing and drying, such as solvent vapors etc. for example. A long, trouble-free service life with little maintenance expenditure can thus be ensured.

Moreover, the construction of a varnish coating plant which is operable in an automated fashion, wherein in a first installation—as the first station—the coating material may be applied in liquid or powder or granulated form and, this can be done advantageously, in a manner known per se, electrostatically and/or by spraying on. A second installation comprises—in a second station—the above described energy transmitter, by which the coating-free material—preferably a powder varnish material—will be thus fusible and/or dryable. This will achieve perfect, well adhesive coatings with very little energy expenditure and short treatment periods. Components to be coated—such as structural metal parts, vehicle bodies or metal housings—can be preferably automatically transported continuously or possibly in cycles in tunnel-type plants by means of transport installations, such as e.g. conveyor belts.

Furthermore, powder varnishes with natural frequencies in the range of wave numbers from approximately 1000 to 1800 cm⁻¹ have proved to be particularly suitable which are applied on components of metal material.

### DESCRIPTION OF THE DRAWINGS

The invention is explained in more detail by means of drawings which are appended hereto and made a part of this disclosure by way of illustration and not limitation. In the drawings:

FIG. 1 a schematic, perspective presentation of an energy transmitter as a component part of a coating and drying plant for a varnish coating;

FIG. 2 a schematic, enlarged detailed presentation of detail A of FIG. 1; and

FIG. 3 a schematic, partly perspective presentation of a transmitter surface element with a radiation layer applied to a rear glass surface.

### DETAILED DESCRIPTION

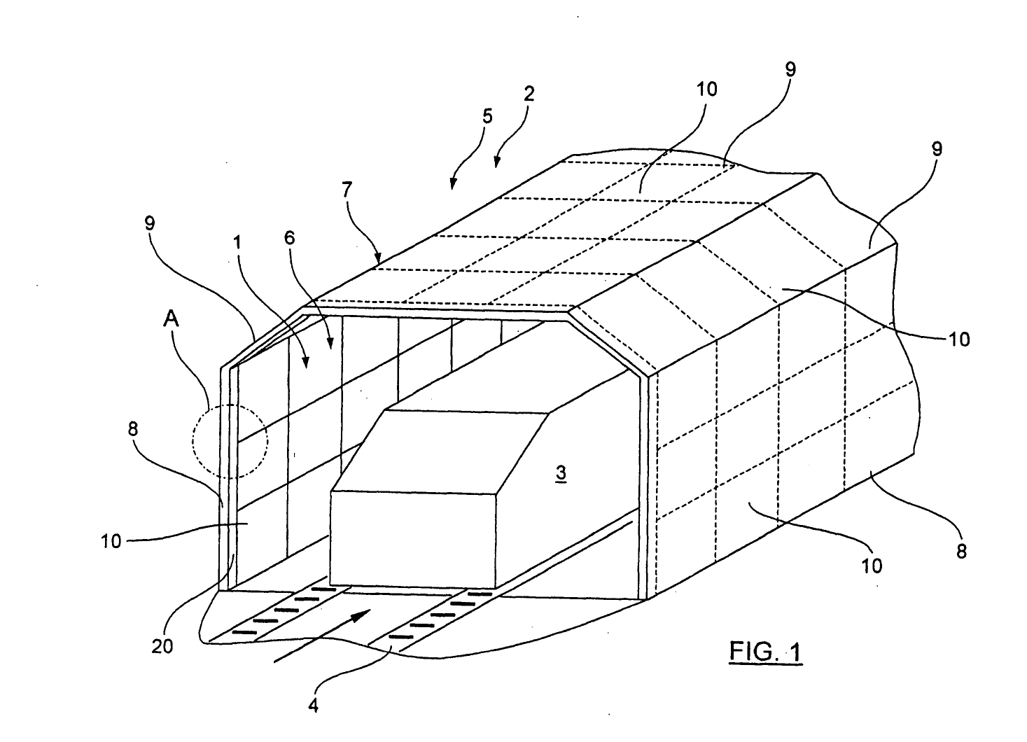

FIG. 1 shows schematically and perspectively an energy transmitter 1 as a component part of a coating and drying plant 2 for varnish coating. This coating and drying plant 2 has—in a first station here not presented—a first installation for the application of e.g. a powder varnish as a coating material on the surface of a component 3 to be coated, e.g. a motor vehicle body. The powder varnish has natural frequencies in the range of the wave numbers from approximately 1000 to 1,800 cm⁻¹ and is electrostatically applied to component 3 in the first installation. Component 3 together with the electrostatically adhesive powder varnish is continuously or in cycles transported by means of transport equipment 4 through the first installation not shown here and —after having run through this first station—it arrives at a second station 5 presented schematically and perspectively in FIG. 1, this second station being downstream from the first station and comprising a tunnel 7 through which the component 3 is transported continuously or in cycles, in the desired manner, by means of transport equipment 4.

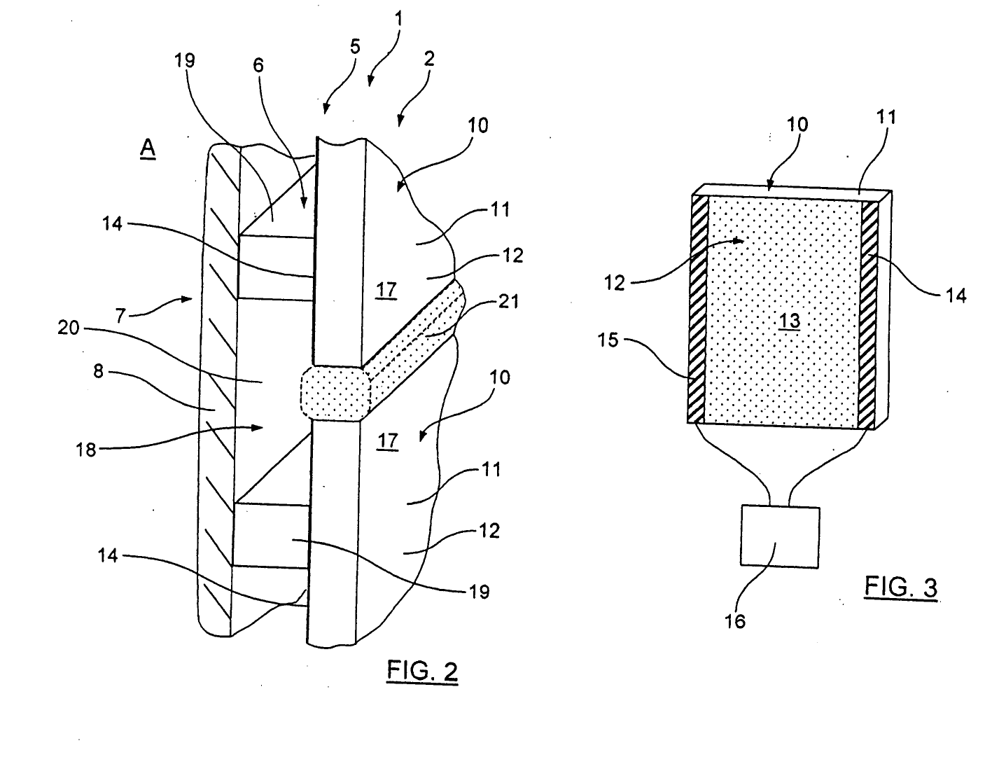

As is particularly evident from FIG. 1, there are—on the inside walls of tunnel 7, i.e. on the side walls 8 and the ceiling walls 9—a plurality each of the transmitter surface elements 10 forming the energy transmitter 1 is arranged which advantageously essentially adjoin each other and e.g. form a narrow gap between themselves in which an elastically insulating sealing tape 21 can be inserted such as this is schematically presented in FIG. 2. This achieves a closed, gas-tight front plane. Here, these transmitter surface elements are designed approximately rectangular in shape and each have a glass carrier plate 11 as is particularly evident from FIGS. 2 and 3 which show enlarged schematic detail presentations. This glass carrier plate 11 has, on a rear glass surface 12, a radiation layer 13, schematically presented by a dot structure in the presentation of FIG. 3. On opposite side areas of this rear glass surface 12, the radiation layer 13 has electrical conductors 14, 15 arranged on it which are connected in parallel with a harmonic generator of a control device 16 presented in FIG. 3 only extremely schematically and by way of example. This harmonic generator of control device 16 comprises an electric block which—upon control with a control oscillation—shows a steep current speed increase in accordance with a steep rising curve and thus being suitable for producing a high harmonic percentage. This way, the transmitter surface elements 10 can be excited with a frequency in the megahertz range or with a frequency in the gigahertz range.

A free front glass surface 17 facing the rear glass surface 12 of the transmitter surface elements 10 is directed towards the motor vehicle body 3.

The inside walls 18 of tunnel 7 here form a surface reflector 20 and are formed of a load-bearable metal plate on which the transmitter surface elements 10 are held via the insulation elements 19 presented in FIG. 2. The distance between the surface reflector 20 and the transmitter surface elements 10 here ranges e.g. from approximately 1 cm to 10 cm.

With regard to the composition of the radiation layer 13, reference is made to patent claims 4 and 5 as well as to the corresponding passages in the preamble of the specification.

As soon as component 3 with the electrostatically adhesive powder varnish is transported through tunnel 7 by means of transport equipment 4, the corresponding radiation layer 13 on transmitter surface elements 10 gives off an electromagnetic radiation in ultrared whose frequency band covers the characteristic natural frequencies of the powder varnish so that this will be fused onto component 3 and dried.

Although the present invention has been described with a certain degree of particularity, it is understood that the present disclosure has been made by way of example and that changes in details or structure may be made without departing from the spirit thereof. Accordingly, my invention is limited only by the scope of the claims that follow:

1. An energy transmitter as a component part of a coating and/or drying plant, especially for varnish coating, comprising:
a) an energy transmitter (1) including at least two transmitter surface elements (10) as antenna elements, each of said transmitter surface elements (10) having a glass carrier plate (11) which bears a radiation layer (13) on a rear glass surface (12) and on the opposite free front glass surface (17) is directed to a position for an object to be dried or a surface of a component (3) with coating material applied,
b) a surface reflector (20) of a metal material being arranged at a distance from and approximately parallel with the rear glass surface (12) and at least in its size;
c) a corresponding radiation layer (13) being designed to give off electromagnetic radiation in a frequency band covering at least the characteristic natural frequencies in ultrared of an object or coating material to be dried; and,
d) the radiation layer (13) being excitable by means of a control device (16) to give off at least the one frequency band so that natural frequencies of the object or the coating material to be dried are excitable in resonance.

2. An energy transmitter as a component part of a coating and/or drying plant according to claim 1, wherein a plurality of rectangular or square transmitter surface elements (10) is used which are arranged side by side in at least one plane.

3. An energy transmitter according to claim 2, wherein an electrically insulating sealing strip is used between the adjoining edges of the transmitter surface elements.

4. An energy transmitter as a component part of a coating and/or drying plant according to claim 3, wherein the transmitter surface elements (10) form interior walls (18) of a tunnel (7) and are arranged on the side walls (8) and/or on the ceiling wall (9) and/or on the floor wall, and that an object to be dried or a component (3) with applied coating material is transportable through the tunnel (7).

5. An energy transmitter as a component part of a coating and/or drying plant according to claim 1 wherein the radiation layer (13) is formed on the glass carrier plates (11) by applying the following coating mass which consists of a binding agent, insulator, dispersing agent, water and graphite and comprises:

| | | |
|---|---|---|
| a. | 55 to 65% | amount of substance of a base |
| | | material, |
| | | comprising: |
| | 39 to 49% | amount of substance binding agent, |
| | 18 to 23% | amount of substance insulator, |
| | 18 to 24% | amount of substance dispersing agent, |
| | 12 to 16% | amount of substance distilled water, |
| | | and |
| b. | 35 to 45% | amount of substance graphite, |
| | | with the binding agent being composed of: |
| | 69.06 to 75.54% | amount of substance distilled water, |
| | 4 to 6% | amount of substance sulfonated oil, |
| | 0.16 to 0.24% | amount of substance phenols, or |
| | 0.05 to 0.5% | amount of substance |
| | | benzisothiazolinone, |
| | 15 to 19% | amount of substance casein, |
| | 0.8 to 1.2% | amount of substance urea, |
| | 2 to 3% | amount of substance thinning agent, and |
| | 2.5 to 3.5% | amount of substance caprolactam. |

6. An energy transmitter as a component part of a coating and/or drying plant according to claim 5, wherein the sulfonated oil is sulfated ricinus oil, the phenols are carbonized phenols produced by cracking or that benzisothiazolinone is used, the thinning agent is an alkaline thinning agent and/or a solvent based on aromatics and/or alcohol and/or ester and/or ketone, the insulator is insulating soot, the dispersing agent is an inorganic and/or organic, monomer and/or polymer substance, and the coating material contains a thixotropic agent.

7. An energy transmitter as a component part of a coating and/or drying plant according to claim 1, wherein the transmitter surface elements (10) each have electrical conductors (14, 15) on opposite side areas of the rear glass surfaces (12) provided with the radiation layer (13), and that all transmitter surface elements are connected in parallel with a harmonic generator of the control device (16), comprising an electric block which, upon control with a control oscillation, shows a steep current increase speed in accordance with a steep rising curve and thus being suitable for generating a high harmonic percentage.

8. An energy transmitter as a component part of a coating and/or drying plant according to claim 1 wherein a number of the transmitter surface elements (10) is excitable with a frequency in the megahertz range and the other transmitter surface elements (10) with a frequency in the gigahertz range.

9. An energy transmitter as a component part of a coating and/or drying plant according to claim 1, wherein the surface reflector (20) is formed of at least one load-bearable metal plate on which the transmitter surface elements (10) are held via insulation elements (19), the distance between the surface reflector (20) and the transmitter surface elements (10) advantageously being approximately 1 cm to 10 cm.

10. An energy transmitter as a component part of a coating and/or drying plant according to claim 1, wherein a first installation is provided for the application of a liquid or powder or granular coating material on at least one part of a surface of a component (3), and that the first installation for the application of the coating material is arranged in a first station through which the component to be coated is capable of being transported continuously or in cycles by means of the transport equipment (4), and that a second installation (6) is provided which comprises the controllable energy transmitter (1) with an effective direction on the surface of the component (3) with the applied coating material, wherein the coating material, advantageously a powder varnish material is fusible and/or dryable by means of the energy transmitter (1), and that the second installation with the energy transmitter is arranged in a second station (5) which is arranged downstream of the first station and through which the component (3) is transportable continuously or in cycles by means of the transport equipment (4).

11. An energy transmitter as a component part of a coating and/or drying plant according to claim 10, wherein the application of the coating material in the first installation is done electrostatically and/or by spraying.

12. An energy transmitter as a component part of a coating and/or drying plant according to claim 1, wherein a powder varnish is used as the coating material, with natural frequencies in the range of wave numbers of approximately 1000 to 1800 cm^{-1.}

13. An energy transmitter as a component part of a coating and/or drying plant according to claim 12, wherein the components (3) to be coated consist of a metal material.
